(19) United States
(12) Patent Application Publication
(10) Pub. No.: US 2024/0335778 A1
(43) Pub. Date: Oct. 10, 2024

(54) Universal Pool Skimmer Adapter Plate Device

(71) Applicant: Richard Grove, Oak Forest, IL (US)

(72) Inventor: Richard Grove, Oak Forest, IL (US)

(21) Appl. No.: 18/586,646

(22) Filed: Feb. 26, 2024

Related U.S. Application Data
(60) Provisional application No. 63/457,465, filed on Apr. 6, 2023.

(51) Int. Cl. B01D 35/30; E04H 4/12

(52) U.S. Cl. CPC B01D 35/306; E04H 4/1272; B01D 2201/347; B01D 2201/4092

(57) ABSTRACT

A universal pool skimmer adapter plate device is provided. The device is comprised of at least one adapter plate, at least one backer plate, at least one gasket, and at least one face plate. Each plate (and gasket) of the device can be secured to one another on both sides of a skimmer opening on an above-ground pool wall to allow a pool skimmer to be easily mounted to an above-ground pool while preventing the skimmer from falling into the pool via the skimmer opening in the pool wall.

### CROSS-REFERENCE TO RELATED APPLICATION

The present application claims priority to, and the benefit of, U.S. Provisional Application No. 63/457,465, which was filed on Apr. 6, 2023, and is incorporated herein by reference in its entirety.

### FIELD OF THE INVENTION

The present invention relates generally to the field of above-ground pools. More specifically, the present invention relates to a universal pool skimmer adapter plate device that allows a pool skimmer to be universally mounted to an above-ground pool. Accordingly, the present disclosure makes specific reference thereto. Nonetheless, it is to be appreciated that aspects of the present invention are also equally applicable to other like applications, devices, and methods of manufacture.

### BACKGROUND

In the field of swimming pool equipment and accessories, it has become increasingly apparent that a significant and persistent need exists for a universal pool skimmer adapter plate device that can seamlessly and securely connect any conventional above-ground swimming pool skimmer to the pool wall. Currently, the absence of a universally adaptable universal pool skimmer adapter plate device poses substantial challenges and inconveniences for pool owners and maintenance professionals alike. Existing options on the market often lack the versatility and compatibility required to accommodate various skimmer designs and pool configurations. As a result, pool owners are compelled to invest significant time and effort in sourcing compatible adapters or, in some cases, resort to cumbersome and less secure makeshift solutions.

By addressing this long-standing issue, a universal pool skimmer adapter plate device would revolutionize the pool industry by providing a much-needed standardized solution. Pool owners and professionals would be able to effortlessly secure any standard above-ground swimming pool skimmer to the pool wall, regardless of its make or model. This adapter would eliminate the need for extensive modifications or customizations, saving both time and money for pool owners.

Therefore, there exists a long-felt need in the art for a universal pool skimmer adapter plate device. More specifically, there exists a long-felt need in the art for a universal pool skimmer adapter plate device that allows any standard above-ground swimming pool skimmer to be securely bolted to a pool wall in a secure manner. In addition, there exists a long-felt need in the art for a universal pool skimmer adapter plate device that allows any standard above-ground swimming pool skimmer to be securely bolted to a pool wall in a secure manner that works in a universal manner.

The subject matter disclosed and claimed herein, in one embodiment thereof, comprises a universal pool skimmer adapter plate device. The device is comprised of at least one adapter plate, at least one backer plate, at least one gasket, and at least one face plate. Each plate (and gasket) of the device can be secured to one another on both sides of a skimmer opening on an above-ground pool wall. The device allows a pool skimmer to be easily mounted to an above-ground pool while preventing the skimmer from falling into the pool via the skimmer opening in the pool wall.

In this manner, the universal pool skimmer adapter plate device of the present invention accomplishes all the foregoing objectives and provides a skimmer adapter plate device. More specifically, the device allows any standard above-ground swimming pool skimmer to be securely bolted to a pool wall in a secure manner. Further, the device works in a universal manner with any standard, small-mouth, above ground pool skimmer.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a universal pool skimmer adapter plate device used to attach a pool skimmer to an above-ground swimming pool while preventing the skimmer from falling through the pool wall via the opening cut for the skimmer. The device is primarily comprised of at least one adapter plate with at least one central water opening that allows water to flow through the plate and into a pool skimmer. In one embodiment, the plate has a plurality of openings (in any pattern/arrangement) that allow a plurality of fasteners to be placed through the plate.

The device is also comprised of at least one backer plate comprised of at least one central water opening that is positioned around an opening of a pool skimmer. The opening allows water to flow into the opening of the skimmer. The back plate is comprised of a frame that preferably mirrors the shape of the skimmer opening.

The frame is comprised of at least one fastener opening that receives the fastener of the adapter plate to secure the plate to the backer plate on both sides of a pool wall. The backer plate may also be comprised of at least one tab for additional support and fastening to the adapter. The tab is comprised of at least one fastener opening that receives the fastener of the adapter plate.

To ensure a watertight seal between the skimmer, pool wall, backer plate, and adapter plate, the device may be comprised of at least one gasket with at least one opening that receives at least one fastener. The gasket is comprised of at least one central opening that allows water to flow through the opening and into the skimmer opening. In the preferred embodiment, at least one gasket is placed between the backer plate and pool and between the adapter plate and face plate.

The adapter plate is protected via the face plate within the interior of a pool. The face plate is comprised of at least one opening that receives at least one face plate fastener that is received by the opening of the adapter plate. The face plate is also comprised of a central water opening that allows water to flow into the skimmer.

The present invention is also comprised of a method of using the device. First, a device is provided comprised of an adapter plate, a backer plate, at least one skimmer gasket, and a skimmer face plate. Then, the backer plate is attached around an opening of a pool skimmer. Next, a first skimmer gasket is placed between the backer plate and around the body of a pool skimmer. Then, a second skimmer gasket is placed on the opposite side of the skimmer adapter plate opening on the inside of the pool wall and an adapter plate is placed over the second skimmer gasket. Then, a fastener is placed through the adapter plate and both skimmer gaskets to secure the adapter plate to the backer plate. Next, a third skimmer gasket is placed over the adapter plate between the pool wall liner and skimmer wherein a face plate is then placed over the third skimmer gasket. Finally, a second fastener is placed through the face plate, gaskets, and skimmer.

Accordingly, the universal pool skimmer adapter plate device of the present invention is particularly advantageous as it provides a skimmer adapter plate device that allows any standard above-ground swimming pool skimmer to be securely bolted to a pool wall in a secure manner. Further, the device works in a universal manner with any pool skimmer. In this manner, the universal pool skimmer adapter plate device provides a solution for attaching pool skimmers to above-ground pools.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a universal pool skimmer adapter plate device of the present invention in accordance with the disclosed architecture; and

FIG. 2 illustrates a flowchart of a method of using one potential embodiment of a universal pool skimmer adapter plate device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a universal pool skimmer adapter plate device. More specifically, there exists a long-felt need in the art for a universal pool skimmer adapter plate device that allows any standard above-ground swimming pool skimmer to be securely bolted to a pool wall in a secure manner. In addition, there exists a long-felt need in the art for a universal pool skimmer adapter plate device that allows any standard above-ground swimming pool skimmer to be securely bolted to a pool wall in a secure manner that works in a universal manner.

The present invention, in one exemplary embodiment, is comprised of a universal pool skimmer adapter plate device used to attach a pool skimmer to an above-ground swimming pool while preventing the skimmer from falling through the pool wall via the opening cut for the skimmer. The device is primarily comprised of at least one adapter plate with at least one central water opening. The opening allows water to flow through the plate and into a pool skimmer. In one embodiment, the plate has a plurality of openings (in any pattern/arrangement) that allow a plurality of fasteners to be placed through the plate.

The device is also comprised of at least one backer plate. The plate is comprised of at least one central water opening that is positioned around an opening of a pool skimmer. The opening allows water to flow into the opening of the skimmer. The back plate is comprised of a frame that preferably mirrors the shape of the skimmer opening.

The frame is comprised of at least one fastener opening that receives the fastener of the adapter plate to secure the plate to the backer plate on both sides of a pool wall. The backer plate may also be comprised of at least one tab for additional support and fastening to the adapter, wherein the tab is comprised of at least one fastener opening that receives the fastener of the adapter plate.

To ensure a watertight seal between the skimmer, pool wall, backer plate, and adapter plate, the device may be comprised of at least one gasket. The gasket has at least one opening that receives at least one fastener. The gasket is comprised of at least one central opening that allows water to flow through the opening and into the skimmer opening. In the preferred embodiment, at least one gasket is placed between the backer plate and pool and between the adapter plate and face plate.

The adapter plate is protected via the face plate within the interior of a pool. The face plate is comprised of at least one opening that receives at least one face plate fastener that is received by the opening of the adapter plate. The face plate is also comprised of a central water opening that allows water to flow into the skimmer.

The present invention is also comprised of a method of using the device. First, a device is provided comprised of an adapter plate, a backer plate, at least one skimmer gasket, and a skimmer face plate. Then, the backer plate is attached around an opening of a pool skimmer and a first skimmer gasket is placed between the backer plate and around an opening of the pool wall. Then, a second skimmer gasket is placed on the opposite side of the opening on the inside of the pool wall and an adapter plate is placed over the second skimmer gasket. Next, a fastener is placed through the adapter plate and both skimmer gaskets to secure the adapter plate to the backer plate. Then, a third skimmer gasket is placed over the adapter plate wherein a face plate is then placed over the third skimmer gasket. Finally, a second fastener is placed through the face plate and a third gasket to secure the face plate to the adapter plate.

Accordingly, the universal pool skimmer adapter plate device of the present invention is particularly advantageous as it provides a skimmer adapter plate device that allows any standard above-ground swimming pool skimmer to be securely bolted to a pool wall in a secure manner. Further, the device works in a universal manner with any pool skimmer. In this manner, the universal pool skimmer adapter plate device provides a solution for attaching pool skimmers to above-ground pools.

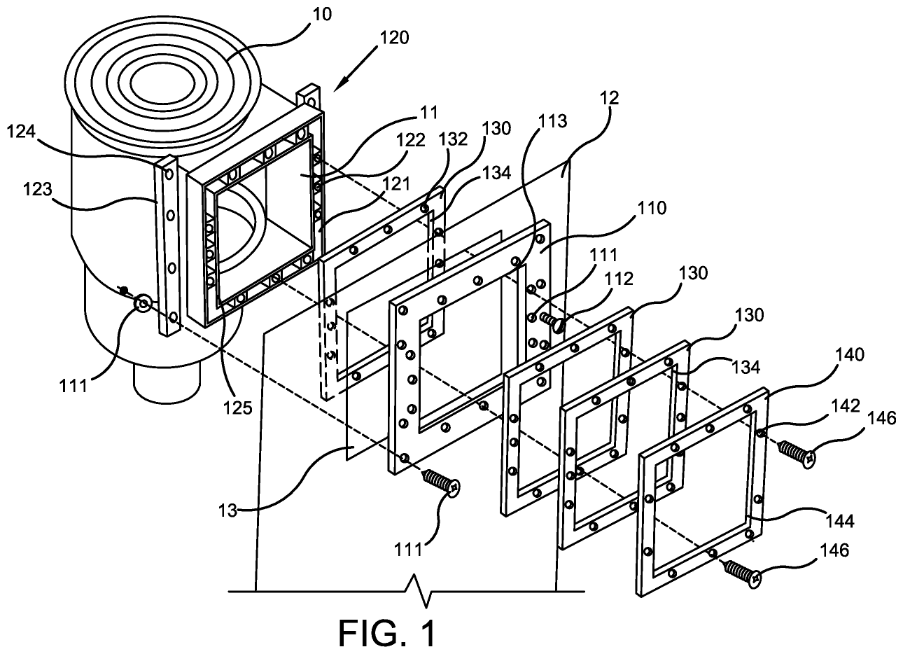

Referring initially to the drawings, FIG. 1 illustrates an exploded view of one potential embodiment of a universal pool skimmer adapter plate device 100 of the present invention in accordance with the disclosed architecture. During use, the device 100 is used to attach a pool skimmer 10 to an above-ground swimming pool while preventing the skimmer 10 from falling through the pool wall 12 via the opening 13 cut for the skimmer 10. The device 100 is preferably sized and configured for use with pool skimmers 10 with inside dimensions of 5⅞″ wide and 5⅝″ tall. However, the device 100 may work with any size and configuration of skimmer 10 in different embodiments. All central openings 113, 125, 134, 144, of the device 100 are preferably the same size (5⅞″ wide and 5⅝″ tall) and shape as the opening 11 of the pool skimmer 10 in any embodiment, but may differ.

The device 100 is primarily comprised of at least one adapter plate 110. The plate 110 is preferably comprised made from aluminum material. The plate 110 is preferably square with at least one central water opening 113 that allows water to flow through the plate 110 and into a pool skimmer 10. The plate 110 further preferably has at least one opening 111. In one embodiment, the plate 110 has a plurality of openings 111 (in any pattern/arrangement) that allow a plurality of fasteners 112, such as, but not limited to, screws, a bolt and nut assembly, a bolt, a nut and washer assembly, etc., to be placed through the plate 110.

More specifically, the device 100 is also comprised of at least one backer plate 120. The backer plate 110 is comprised of at least one central water opening 125 that is positioned around an opening 11 of a pool skimmer 10. The opening 125 allows water to flow into the opening 11 of the skimmer 10. The back plate 120 is comprised of a frame 121 that preferably mirrors the shape of the skimmer opening 11.

The frame 121 is comprised of at least one fastener opening 122 that receives the fastener 112 of the adapter plate 110 to secure the plate 110 to the backer plate 120 on both sides of a pool wall 12. The backer plate 120 may also be comprised of at least one tab 123 for additional support and fastening to the adapter 110. The tab 123 is comprised of at least one fastener opening 124 that receives the fastener 112 of the adapter plate 110.

To ensure a watertight seal between the skimmer 10, pool wall 12, backer plate 120, and adapter plate 110, the device 110 may be comprised of at least one gasket 130. The gasket 130 may be comprised of a rubber material or any other compressible material known in the art. The gasket 130 has at least one opening 132 that receives at least one fastener 112. The gasket 130 is comprised of at least one central opening 134 that allows water to flow through the opening 134 and into the skimmer opening 111. In the preferred embodiment, at least one gasket 130 is placed between the backer plate 120 and pool 11 and between the adapter plate 110 and face plate 140. In one embodiment, at least one gasket 130 is also present between the adapter plate 110 and face plate 140.

The adapter plate 110 is protected via the face plate 140 within the interior of a pool. The face plate 140 is comprised of at least one opening 142 that receives at least one face plate fastener 146, such as, but not limited to, a screw, a bolt and nut assembly, a bolt, a nut and washer assembly, etc., that is received by the opening 111 of the adapter plate 110. The face plate 140 is also comprised of a central water opening 144 that allows water to flow into the skimmer.

In one embodiment, each fastener opening 111,122,124,132,142 of each component of the device 100 is threaded to receive a threaded fastener 112,146.

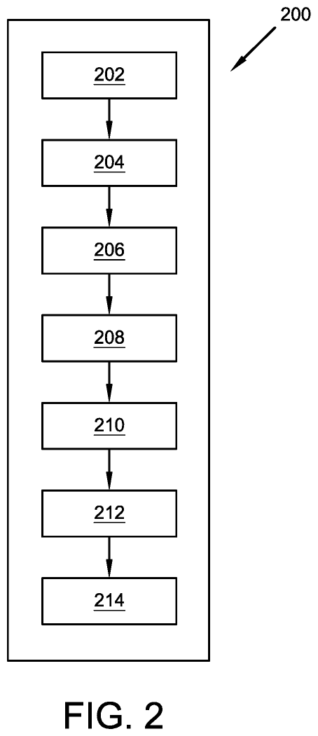

The present invention is also comprised of a method of using 200 the device 100, as seen in FIG. 2. First, a device 100 is provided comprised of an adapter plate 110, a backer plate 120, at least one skimmer gasket 130, and a skimmer face plate 140 [Step 202]. Then, the backer plate 120 is attached around an opening 11 of a pool skimmer 10 [Step 204]. Next, a first skimmer gasket 130 is placed between the backer plate 120 and around the body of a pool skimmer 10 [Step 206]. Then, a second skimmer gasket 130 is placed on the opposite side of the skimmer adapter plate 110 opening 13 on the inside of the pool wall 12 and an adapter plate 110 is placed over the second skimmer gasket 130 [Step 208]. Then, a fastener 112 is placed through the adapter plate 110 and both skimmer gaskets 130 to secure the adapter plate 110 to the backer plate 120 [Step 210]. Next, a third skimmer gasket 130 is placed over the adapter plate 110 between the pool wall 12 liner and skimmer 10 wherein a face plate 140 is then placed over the third skimmer gasket 130 [Step 212]. Finally, a second fastener 146 is placed through the face plate 140, gaskets 130, and skimmer 10 [Step 214].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “universal pool skimmer adapter plate device” and “device” are interchangeable and refer to the universal pool skimmer adapter plate device 100 of the present invention.

Notwithstanding the foregoing, the universal pool skimmer adapter plate device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the universal pool skimmer adapter plate device 100 as shown in the FIGS. are for illustrative purposes only, and that many other sizes and shapes of the universal pool skimmer adapter plate device 100 are well within the scope of the present disclosure. Although the dimensions of the universal pool skimmer adapter plate device 100 are important design parameters for user convenience, the universal pool skimmer adapter plate device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A universal pool skimmer adapter plate device comprising:
a backer plate comprised of a first fastener opening;
an adapter plate comprised of a second fastener opening;
a first skimmer gasket comprised of a third fastener opening; and
a skimmer face plate comprised of a fourth fastener opening.

2. A universal pool skimmer adapter plate device of claim 1 further comprised of a second skimmer gasket.

3. A universal pool skimmer adapter plate device of claim 1, wherein the first skimmer gasket is positioned between the backer plate and the adapter plate.

4. A universal pool skimmer adapter plate device of claim 2, wherein the second skimmer gasket is positioned between the adapter plate and the skimmer face plate.

5. A universal pool skimmer adapter plate device of claim 1, wherein the backer plate is comprised of a first central opening.

6. A universal pool skimmer adapter plate device of claim 1, wherein the adapter plate is comprised of a second central opening.

7. A universal pool skimmer adapter plate device of claim 1, wherein the first skimmer gasket is comprised of a third central opening.

8. A universal pool skimmer adapter plate device of claim 1, wherein the skimmer face plate is comprised of a fourth central opening.

9. A universal pool skimmer adapter plate device of claim 1, wherein the first fastener opening, the second fastener opening, the third fastener opening, and the fourth fastener opening are comprised of a threaded opening.

10. A universal pool skimmer adapter plate device comprising:
a backer plate comprised of a first backer plate opening and a second backer plate opening;
an adapter plate comprised of a first adapter plate opening and a second adapter plate opening;
a first skimmer gasket comprised of a first skimmer gasket opening and a second skimmer gasket opening; and
a skimmer face plate comprised of a first skimmer face plate opening and a second skimmer face plate opening.

11. A universal pool skimmer adapter plate device of claim 10, wherein the second backer plate opening is comprised of a first threaded opening.

12. A universal pool skimmer adapter plate device of claim 10, wherein the second adapter plate opening is comprised of a second threaded opening.

13. A universal pool skimmer adapter plate device of claim 1, wherein the second skimmer gasket opening is comprised of a third threaded opening.

14. A universal pool skimmer adapter plate device of claim 1, wherein the second skimmer face plate opening is comprised of a fourth threaded opening.

15. A universal pool skimmer adapter plate device of claim 10, wherein the backer plate is comprised of a tab.

16. A universal pool skimmer adapter plate device of claim 15, wherein the tab is comprised of a threaded opening.

17. A method of using a universal pool skimmer adapter plate device, the method comprising the following steps:
providing a universal pool skimmer adapter plate device comprised of an adapter plate, a backer plate, a first skimmer gasket, and a skimmer face plate;
placing a first skimmer gasket between the backer plate and around an opening of a pool wall;
placing a second skimmer gasket on an opposite side of the opening of the pool wall;
placing the adapter plate over the second skimmer gasket;
placing a first fastener through the adapter plate, the second skimmer gasket, the first skimmer gasket, and the backer plate;
placing a third skimmer gasket over the adapter plate;
placing the skimmer face plate over the third skimmer gasket; and
placing a second fastener through the skimmer face plate, the third skimmer gasket, and the adapter plate.

18. The method of using a universal pool skimmer adapter plate device of claim 17, wherein the first fastener is comprised of a threaded fastener.

19. The method of using a universal pool skimmer adapter plate device of claim 17, wherein the second fastener is comprised of a threaded fastener.

20. The method of using a universal pool skimmer adapter plate device of claim 17, wherein the first fastener is received by a tab of the backer plate.
